(19) United States
(12) Patent Application Publication
(10) Pub. No.: US 2020/0219482 A1
(43) Pub. Date: Jul. 9, 2020

(54) ELECTRONIC DEVICE FOR PROCESSING USER SPEECH AND CONTROL METHOD FOR ELECTRONIC DEVICE

(71) Applicant: SAMSUNG ELECTRONICS CO., LTD., Suwon-si (KR)

(72) Inventors: Min Sup KIM, Suwon-si (KR); Seok Woo YONG, Seoul (KR); Hyun Kyu YUN, Seoul (KR)

(73) Assignee: SAMSUNG ELECTRONICS CO., LTD., Suwon-si (KR)

(21) Appl. No.: 16/648,536

(22) PCT Filed: Sep. 13, 2018
(86) PCT No.: PCT/KR2018/010769

§ 371 Date: Mar. 18, 2020

(30) Foreign Application Priority Data
Sep. 21, 2017 (KR) 10-2017-0122097

(51) Int. Cl. G10L 15/04; G10L 15/22

(52) U.S. Cl. CPC G10L 15/04; G10L 15/22

(57) ABSTRACT

Disclosed is an electronic device including a communication circuit, a memory, a microphone, and a processor electrically connected to the communication circuit, the microphone, and the memory. The processor may be configured to receive a user utterance including a specified word through the microphone, to calculate a first confidence level of the received user utterance, to receive a second confidence level of the user utterance calculated by an external electronic device, from the external electronic device through the communication circuit, to compare the first confidence level and the second confidence level, and to perform an operation corresponding to the user utterance when the first confidence level is higher than the second confidence level. Other various embodiments as understood from the specification are also possible.

### TECHNICAL FIELD

Embodiments disclosed in the disclosure refer to a technology for processing a user utterance.

### BACKGROUND ART

Electronic devices have recently supported various input schemes such as a voice input and the like together with a conventional input method using a keyboard or a mouse. For example, electronic devices such as a smart phone and a tablet may recognize a user's voice by using a speech recognition function and provide a service corresponding to the recognized voice input.

When receiving a trigger signal, an electronic device may activate a function for recognizing a voice input. The trigger signal for activating the speech recognition function may be a signal generated through a hardware or software button or may be a signal generated by receiving a voice input including a specific word via a microphone. The electronic device may process the user utterance for implementing a plurality of functions of the electronic device through an activated speech recognition function.

### DISCLOSURE

### Technical Problem

When the speech recognition function is activated by the same voice input, in a plurality of electronic devices positioned in a space capable of receiving the same voice input, the speech recognition functions of the plurality of electronic devices that the user does not want may be activated by the user utterance for activating a speech recognition function of a specific electronic device.

For the purpose of preventing speech recognition functions of the plurality of electronic devices from being activated by the same user utterance, the plurality of electronic devices may need to be set such that the speech recognition function is activated by different user utterances. In addition, the speech recognition function of the specific electronic device desired by the user may be activated by controlling the plurality of electronic devices through a server, but the plurality of electronic devices needs to be registered in the server and needs to be connected to the server using an ID for controlling the registered electronic device. Accordingly, in the method, it may be difficult to adapt to the changed environment such as the case where another unregistered device is newly positioned in a specified space.

Various embodiments of the disclosure suggest a method of activating a speech recognition function of an electronic device, which is desired by a user, from among a plurality of electronic devices that receive the same user utterance.

### Technical Solution

According to an embodiment disclosed in the disclosure, an electronic device may include a communication circuit, a memory, a microphone, and a processor electrically connected to the communication circuit, the microphone, and the memory. The processor may be configured to receive a user utterance including a specified word through the microphone, to calculate a first confidence level of the received user utterance, to receive a second confidence level of the user utterance calculated by an external electronic device, from the external electronic device through the communication circuit, to compare the first confidence level and the second confidence level, and to perform an operation corresponding to the user utterance when the first confidence level is higher than the second confidence level.

Furthermore, according to an embodiment disclosed in the disclosure, an electronic device may include a communication circuit, a memory, a microphone, and a processor electrically connected to the communication circuit, the microphone, and the memory. The processor may be configured to receive a user utterance including a specified word through the microphone, to calculate a first confidence level of the received user utterance, to transmit the first confidence level to an external server through the communication circuit, and to perform an operation corresponding to the user utterance when the first confidence level is higher than the second confidence level by comparing the first confidence level with a second confidence level of the user utterance calculated by an external electronic device through the external server.

### Advantageous Effects

According to embodiments disclosed in the disclosure, when a plurality of electronic devices in each of which a speech recognition function is activated by the same voice input are positioned in a space capable of receiving the same voice input, the plurality of electronic devices may determine the electronic device the user wants to activate the speech recognition function, by analyzing the received user utterance. Accordingly, it is possible to prevent another electronic device, which the user does not want, to be activated.

Furthermore, the plurality of electronic devices determined as receiving the same voice input may output a specified signal and may determine whether the plurality of electronic devices are adjacent to one another by receiving signals output from other electronic devices, thereby preventing an electronic device capable of activating the speech recognition function from being determined among the plurality of electronic devices positioned in different spaces. Accordingly, the speech recognition function of the electronic device desired by the user may be activated.

Besides, a variety of effects directly or indirectly understood through the disclosure may be provided.

### DESCRIPTION OF DRAWINGS

FIG. 1 is a diagram illustrating a voice processing system, according to various embodiments of the disclosure.

FIG. 2 is a diagram illustrating determining an electronic device to be activated by transmitting and receiving a confidence level calculated between electronic devices, according to an embodiment of the disclosure.

FIG. 3 is a diagram illustrating that an electronic device determines another adjacent electronic device, according to an embodiment of the disclosure.

FIG. 4 illustrates that electronic devices determine an electronic device to be activated by transmitting a confidence level to a server, according to an embodiment of the disclosure.

FIG. 5 is a flowchart illustrating a method of processing a user utterance in an electronic device, according to an embodiment of the disclosure.

With regard to description of drawings, the same or similar elements may be marked by the same or similar reference numerals.

### MODE FOR INVENTION

Hereinafter, various embodiments of the disclosure will be described with reference to accompanying drawings. However, those of ordinary skill in the art will recognize that modification, equivalent, and/or alternative on various embodiments described herein can be variously made without departing from the scope and spirit of the disclosure. With regard to description of drawings, similar components may be marked by similar reference marks/numerals.

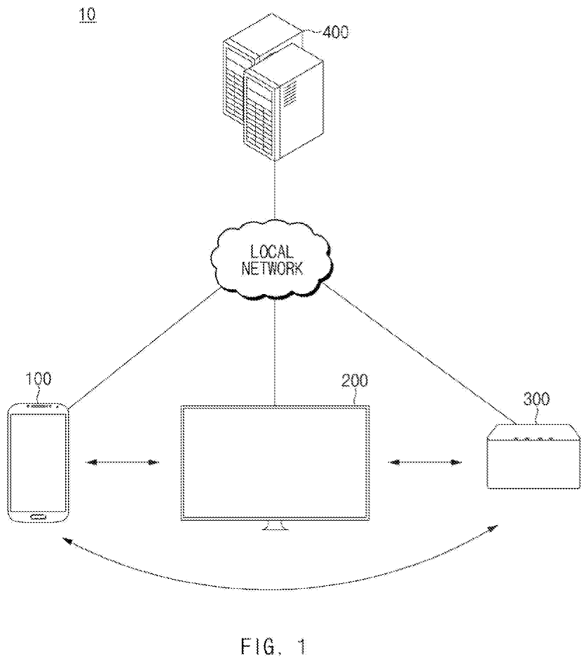

FIG. 1 is a diagram illustrating a voice processing system, according to various embodiments of the disclosure.

Referring to FIG. 1, a voice processing system 10 may include a first electronic device 100, a second electronic device 200, a third electronic device 300, and a server 400.

According to an embodiment, the first electronic device 100 may receive a voice input and may recognize the received voice input. The first electronic device 100 may perform an operation corresponding to the recognized voice input. For example, the first electronic device 100 may recognize a specified word included in the received voice input and then may perform an operation corresponding to the voice input based on the recognized word.

According to an embodiment, the first electronic device 100 may receive a voice input including a specified word and may recognize the specified word included in the received voice input to change the state of the first electronic device 100. For example, the first electronic device 100 may receive a user utterance including a specified word (or a trigger word) and may change the state of the first electronic device 100 from a standby state to an activated state. For example, the standby state may be a state for recognizing only the voice input including a specified word; the activation state may be a state for performing the overall operation of the first electronic device 100. The overall operation may be an operation for implementing the function of the first electronic device 100. Accordingly, the first electronic device 100 may recognize a voice input for performing the overall operation in the activation state and may perform an operation corresponding to the voice input.

According to an embodiment, the first electronic device 100 may provide a user with a user interface (UI) capable of processing a voice input through a display. For example, the first electronic device 100 may be a smart phone.

According to an embodiment, similarly to the first electronic device 100, the second electronic device 200, and the third electronic device 300 may receive the user's voice input and may perform an operation corresponding to the received voice input. For example, the second electronic device 200 and third electronic device 300 may receive a voice input including the specified word and may change from the standby state to the activation state.

According to an embodiment, the second electronic device 200 may be a display device (e.g., television (TV)) that provides the user with an image through a display. According to an embodiment, the third electronic device 300 may be a speaker device (e.g., a wired/wireless speaker) that outputs a signal through a speaker.

According to an embodiment, the first electronic device 100, the second electronic device 200, and the third electronic device 300 may be connected to each other through the same local network. The first electronic device 100, the second electronic device 200, and the third electronic device 300 may share information about the received voice input with electronic devices connected to the same local network (or a sub network). According to an embodiment, the first electronic device 100, the second electronic device 200, and the third electronic device 300 may be connected to the server 400 via the network.

According to an embodiment, the server 400 may receive data from at least one of the first electronic device 100, the second electronic device 200, and the third electronic device 300 and may transmit data determined based on the received data to at least one of the first electronic device 100, the second electronic device 200, and the third electronic device 300.

When receiving a user input including the same word (or a specified word), the first electronic device 100, the second electronic device 200, and the third electronic device 300 may be changed from a standby state to an activation state. Accordingly, when the first electronic device 100, the second electronic device 200, and the third electronic device 300 are positioned in a space capable of receiving the same voice input, the state of at least one of the second electronic device 200 and the third electronic device 300 may be changed to an activation state, in response to a user utterance for changing the state of the first electronic device 100 to an activation state. An electronic device according to various embodiments of the disclosure may change the state of an electronic device that a user desires to operate.

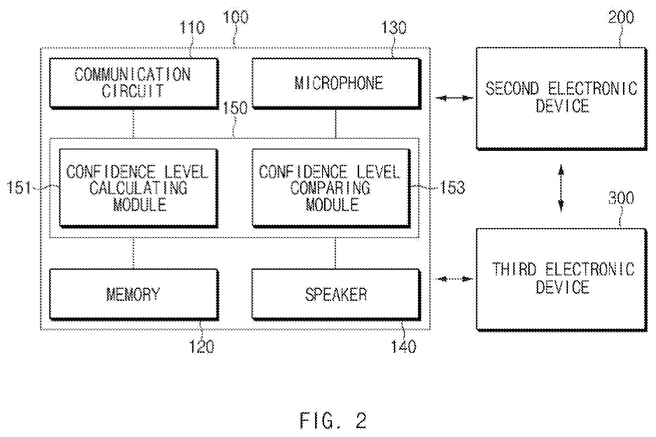

FIG. 2 is a diagram illustrating determining an electronic device to be activated by transmitting and receiving a confidence level calculated between electronic devices, according to an embodiment of the disclosure.

Referring to FIG. 2, when receiving a user utterance including a specified word, the first electronic device 100, the second electronic device 200, and the third electronic device 300 may determine the electronic device, which a user desires, by calculating a confidence level of the received user utterance.

According to an embodiment, the first electronic device 100, the second electronic device 200, and the third electronic device 300 may be connected to the same local network. For example, when being connected to the same local network, the first electronic device 100, the second electronic device 200, and the third electronic device 300 may be positioned to be adjacent to the first electronic device 100. According to an embodiment, the second electronic device 200 and the third electronic device 300 may receive the same user utterance as the first electronic device 100 positioned to be adjacent to each other. In other words, the first electronic device 100, the second electronic device 200, and the third electronic device 300 may receive the utterance by the same user.

According to an embodiment, the first electronic device 100 may include a communication circuit 110, a memory 120, a microphone 130, a speaker 140, and a processor 150. The processor 150 may be electrically connected to the communication circuit 110, the memory 120, the microphone 130, and the speaker 140. In addition, the first electronic device (e.g., a smart phone) 100 may further include a display for providing a UI.

According to an embodiment, the communication circuit 110 may be connected to an external device to transmit or receive data. For example, the communication circuit 110 is connected to the external device through a wired communication network (e.g., a cable network, a public switched telephone network (PSTN), or the like) or a wireless communication network (e.g., code division multiple access (CDMA), wideband code division multiple access (WCDMA), global system for mobile communications (GSM), evolved packet core (EPC), long term evolution (LTE), or the like) to transmit and receive data.

According to an embodiment, the memory 120 may store information (or data) necessary for the operation of the first electronic device 100. For example, the memory 120 may store information for recognizing the voice input of the first electronic device 100. For example, the information for recognizing the voice input may include information for recognizing a specified word for changing the state of the first electronic device 100 to an activation state.

According to an embodiment, the microphone 130 may receive a voice input. For example, the microphone 130 may receive a voice input by detecting an utterance by the user to generate a signal corresponding to the detected utterance. According to an embodiment, the speaker 140 may output a voice signal. The speaker 140 may convert an electrical signal to a sound to output the sound.

According to an embodiment, the processor 150 may be electrically connected to the communication circuit 110, the memory 120, the microphone 130, and the speaker 140 so as to control the overall operation of the first electronic device 100.

According to an embodiment, the first electronic device 100 may include the at least one processor 150. For example, the first electronic device 100 may include a plurality of processors 150 capable of executing at least one function. According to an embodiment, the processor 150 may be implemented with a system on chip (SoC) that includes a central processing unit (CPU), a graphic processing unit (GPU), a memory, and the like.

According to an embodiment, the processor 150 may receive a voice input through the microphone 130. According to an embodiment, the processor 150 may recognize the received user utterance. For example, the processor 150 may recognize the received voice input based on a speech recognition database stored in the memory 130. According to another embodiment, the processor 150 may transmit a request for processing the received voice input to an external server (e.g., the server 400 of FIG. 1) through the communication circuit 110 and may receive a response including the result of recognizing the user utterance from the external server. In other words, the processor 150 may recognize the received user input via the external server. According to an embodiment, the processor 150 may perform an operation corresponding to the recognized utterance.

According to an embodiment, the processor 150 may recognize a user utterance including a specified word (or a trigger word). For example, the processor 150 may calculate the similarity by comparing the recognition result of the predetermined word (e.g., “hi!”) with the received user utterance; when the calculated similarity is higher than a specified threshold, the processor 150 may recognize the specified word included in the voice input. For example, the threshold may be determined using experimental data obtained by recognizing the specified word.

According to an embodiment, when the processor 150 recognizes the specified word included in the voice input, the processor 150 may change the state of the first electronic device 100. For example, the processor 150 may change the first electronic device 100 from a standby state to an activation state.

According to an embodiment, the processor 150 may include a confidence level calculating module 151 and a confidence level comparing module 153 for determining an electronic device desired by a user among a plurality of electronic devices having received the same voice input. The same voice input may be the utterance by the same user. In addition, the same voice input may include a specified word for changing the state of the first electronic device 100 to an activation state. According to an embodiment, the processor 150 may calculate the confidence level of a voice input recognized as including the specified word.

According to an embodiment, the confidence level calculating module 151 may calculate a confidence level (or a first confidence level) of the voice input including the specified word. For example, the confidence level calculating module 151 may be calculated based on at least one of the similarity between the recognized voice input and the voice signal stored in the memory and the magnitude of the sound pressure of the voice input. For example, the voice signal stored in the memory may be a voice signal corresponding to a recognition result of the predetermined voice input. The voice input may include the specified word.

According to an embodiment, the processor 150 may transmit the calculated confidence level to an external electronic device through the communication circuit 110. Furthermore, the processor 150 may receive the calculated confidence level (or a second confidence level and a third confidence level) from the external electronic device that receives the same voice input through the communication circuit 110. For example, the processor 150 may transmit/receive (or share) the calculated confidence level with the second electronic device 200 and the third electronic device 300 through the connected local network.

According to an embodiment, the confidence level comparing module 153 may compare the calculated confidence level with the confidence level received from the external electronic device. For example, when the confidence level comparing module 153 receives the confidence level received from the external electronic device within a specified time from a point in time when the voice input is received, the confidence level comparing module 153 may compare the first confidence level with the second confidence level and the third confidence level.

According to an embodiment, the processor 150 may change the state of the first electronic device 100 from a standby state to an activation state depending on the result calculated by the confidence level comparing module 153. For example, when the first confidence level is higher than the second confidence level and the third confidence level in the confidence level comparing module 153, the processor 150 may change the state of the first electronic device 100 from a standby state to an activation state. The standby state may be a state for recognizing only the voice input including a specified word; the activation state may be a state capable of recognizing a voice input for performing the overall operation of the electronic device.

According to an embodiment, when the state of the first electronic device 100 is changed to the activation state, the processor 150 may receive a voice input for performing the overall operation, through the microphone 130. According to an embodiment, the processor 150 may implement a function of the first user terminal 100 by executing an operation corresponding to the received voice input.

According to an embodiment, the second electronic device 200 and the third electronic device 300 may include a configuration similar to the first electronic device 100. According to an embodiment, similarly to the first electronic device 100, the second electronic device 200 and the third electronic device 300 may process a voice input.

According to an embodiment, when the second electronic device 200 and the third electronic device 300 receive the same voice input, the standby state may be changed to the activation state. For example, when the second electronic device 200 and the third electronic device 300 recognize the specified word included in the voice input, the standby state may be changed to the activation state. The voice information stored in the memory to recognize the specified word of the second electronic device 200 and the third electronic device 300 may be the same as the voice signal stored in the memory 130 to recognize the specified word of the first electronic device 100.

According to an embodiment, the second electronic device 200 and the third electronic device 300 may calculate the confidence level (or the second confidence level and the third confidence level) of the received voice input. According to an embodiment, the second electronic device 200 and the third electronic device 300 may transmit the calculated confidence level to an external electronic device (e.g., the first electronic device 100). Moreover, the second electronic device 200 and the third electronic device 300 may receive the confidence level (or the first confidence level) calculated by the external electronic device (e.g., the first electronic device 100). For example, the second electronic device 200 and the third electronic device 300 may transmit/receive (or share) the calculated confidence level with the first electronic device 100 through the connected local network. According to an embodiment, when the calculated confidence level (e.g., the second confidence level and the third confidence level) is higher than the first confidence level, the standby state may be changed to the activation state in the second electronic device 200 or the third electronic device 300.

Accordingly, the voice processing system 10 may determine an electronic device, which is desired by a user, from among electronic devices that receive the same voice input, and may change the electronic device desired by the user to the activation state.

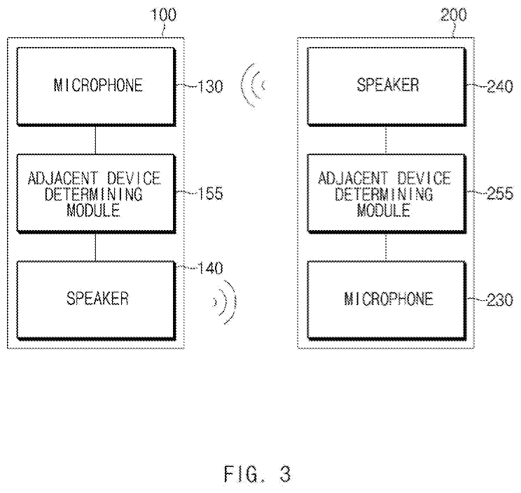

FIG. 3 is a diagram illustrating that an electronic device determines another adjacent electronic device, according to an embodiment of the disclosure.

Referring to FIG. 3, the plurality of electronic devices may determine whether the plurality of electronic devices are adjacent to one another by transmitting and receiving a specified signal. For example, the first electronic device 100 and the second electronic device 200 may transmit a specified signal and may determine whether the first electronic device 100 and the second electronic device 200 are adjacent to each other, depending on the received signal.

According to an embodiment, the first electronic device 100 and the second electronic device 200 may be connected to the same local network, but may be positioned in different spaces. In other words, the first electronic device 100 and the second electronic device 200 may not be positioned in a space capable of receiving the same voice input. For example, the first electronic device 100 and the second electronic device 200 connected to the same local network may not be disposed to be adjacent to each other. In other words, the first electronic device 100 and the second electronic device 200 may be positioned in different spaces (e.g., different floors) incapable of receiving the same voice input. For example, electronic devices that are not positioned to be adjacent to one another do not need to change states by comparing the calculated confidence levels with each other.

For example, the first electronic device 100 and the second electronic device 200 may be positioned in different spaces and may receive user inputs including the specified word from different users. In other words, the first electronic device 100 and the second electronic device 200 may receive different voice inputs that include the specified word. For example, the voice input received by the first electronic device 100 may not be delivered to the second electronic device 200. Furthermore, the voice input received by the second electronic device 200 may not be delivered to the first electronic device 200. However, differently from the voice input, the signal for transmitting the confidence level calculated by the first electronic device 100 may be transmitted to the second electronic device 200. In addition, the signal for transmitting the confidence level calculated by the second electronic device 100 may be transmitted to the first electronic device 100. In this case, the first electronic device 100 and the second electronic device 200 do not need to compare the calculated confidence level with the confidence level received from another electronic device. In other words, when the first electronic device 100 and the second electronic device 200 are not adjacent to each other even though being connected to the same network, the first electronic device 100 and the second electronic device 200 may not compare the calculated confidence level with the confidence level received from another electronic device.

According to an embodiment, the first electronic device 100 and the second electronic device 200 may output the specified signal through the speakers 140 and 240. For example, when the first electronic device 100 and the second electronic device 200 calculate the confidence level of the received voice input, the first electronic device 100 and the second electronic device 200 may output the specified signal through the speakers 140 and 240. For example, the specified signal being output may be an inaudible signal (e.g., a signal in a frequency band of 10 kHz to 300 GHz). Furthermore, the specified signal being output may be adjusted such that sound pressure is low. Accordingly, the user may not recognize the output specified signal.

According to an embodiment, the first electronic device 100 and the second electronic device 200 may receive the output signal via the microphones 130 and 230. According to an embodiment, the adjacent device determining module 155 included in the first electronic device 100 (e.g., the processor 150) may determine whether the second electronic device 200 outputting the signal is adjacent, through the received signal. In addition, the adjacent device determining module 255 included in the second electronic device 200 (e.g., a processor) may determine whether the first electronic device 100 outputting the signal is adjacent, through the received signal. For example, the first electronic device 100 and the second electronic device 200 may calculate the magnitude (e.g., sound pressure) of the received signal; when the calculated magnitude is not less than a specified value, the first electronic device 100 and the second electronic device 200 may determine that another electronic device (e.g., the first electronic device 100 or the second electronic device 200) is adjacent.

According to an embodiment, when it is determined that the other electronic device is not adjacent, the first electronic device 100 and the second electronic device 200 may not compare the calculated confidence level with the confidence level received from another electronic device. Also, when it is determined that another electronic device is adjacent, the first electronic device 100 and the second electronic device 200 may compare the calculated confidence level with the confidence level received from another electronic device.

According to another embodiment, when the first electronic device 100 and the second electronic device 200 receive a voice input containing the specified word, the first electronic device 100 and the second electronic device 200 may output a specified signal through the speakers 140 and 240. For example, when recognizing the specified word included in the received voice input, the first electronic device 100 and the second electronic device 200 may output a specified signal through the speakers 140 and 240. Accordingly, when the first electronic device 100 and the second electronic device 200 are not adjacent to each other, the first electronic device 100 and the second electronic device 200 may not calculate the confidence level of the received voice input.

Accordingly, the first electronic device 100 and the second electronic device 200 which are not adjacent to each other may compare confidence levels of the received voice inputs, thereby preventing the state from being changed differently from the user intent.

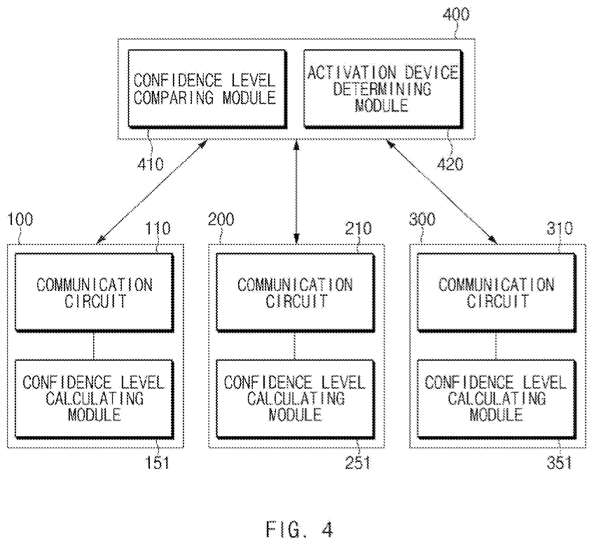

FIG. 4 illustrates that electronic devices determine an electronic device to be activated by transmitting a confidence level to a server, according to an embodiment of the disclosure.

Referring to FIG. 4, when receiving a voice input including a specified word, the first electronic device 100, the second electronic device 200, and the third electronic device 300 may determine a device desired by a user through the server 400 to change the state of the electronic device.

According to an embodiment, when receiving a voice input including the specified word, the first electronic device 100, the second electronic device 200, and the third electronic device 300 may calculate a confidence level for the voice input and then may transmit the calculated confidence level to the server 400. According to an embodiment, the server 400 may select an electronic device receiving the highest confidence level by comparing the confidence levels received from the first electronic device 100, the second electronic device 200, and the third electronic device 300.

According to an embodiment, when receiving a voice input including the specified word, the confidence level calculating module 151 of the first electronic device 100 may calculate a confidence level (or a first confidence level) of the received voice input. According to an embodiment, the first electronic device 100 may transmit the calculated confidence level to the server 400 through the communication circuit 110.

According to an embodiment, the second electronic device 200 may receive the same voice input as the first electronic device 100. For example, the received voice input may include the specified word. According to an embodiment, the confidence level calculating module 251 of the second electronic device 200 may calculate a confidence level (or a second confidence level) of the received voice input. According to an embodiment, the calculated confidence level may be transmitted to the server 400 through the communication circuit 210 of the second electronic device 200.

According to an embodiment, the third electronic device 300 may receive the same voice input as the first electronic device 100 and the second electronic device 200. According to an embodiment, the confidence level calculating module 351 of the third electronic device 300 may calculate a confidence level (or a third confidence level) of the received voice input. According to an embodiment, the calculated confidence level may be transmitted to the server 400 through the communication circuit 310 of the third electronic device 300.

According to an embodiment, the server 400 may receive confidence levels from the first electronic device 100, the second electronic device 200, and the third electronic device 300 that receive the same voice input including the specified word. According to an embodiment, the server 400 may compare the received confidence levels to determine an electronic device to be changed to the activation state. According to an embodiment, the server 400 may include a confidence level comparing module 410 and an activation device determining module 420.

According to an embodiment, the confidence level comparing module 410 may compare the received confidence levels. For example, the confidence level comparing module 410 may compare the first confidence level, the second confidence level, and the third confidence level. Accordingly, the confidence level comparing module 410 may select the highest confidence level.

According to an embodiment, the activation device determining module 420 may determine that the electronic device calculating the highest confidence level is the electronic device, of which the state is to be changed (or to be activated). According to an embodiment, the activation device determining module 420 may transmit a request for changing the state, to the determined electronic device. For example, the activation device determining module 420 may transmit a request for changing the state, to the electronic device calculating the highest confidence level among the first confidence level, the second confidence level, and the third confidence level.

According to an embodiment, an electronic device, which receives the request from the server 400, from among the first electronic device 100, the second electronic device 200, and the third electronic device 300 may be changed to an activation state for recognizing the voice input for controlling the overall operation of the electronic device. For example, when receiving the request from the server 400, the first electronic device 100 may change from a standby state to an activation state.

According to an embodiment, when receiving a confidence level from the first electronic device 100, the second electronic device 200, and the third electronic device 300, the server 400 may determine whether the first electronic device 100, the second electronic device 200, and the third electronic device 300 are adjacent to one another. For example, the server 400 may determine whether the first electronic device 100, the second electronic device 200, and the third electronic device 300 are adjacent to one another, depending on information stored in advance in a database. For another example, according to the method described in FIG. 3, the server 400 may request the first electronic device 100, the second electronic device 200, and the third electronic device 300 to transmit a specified signal and may determine whether the first electronic device 100, the second electronic device 200, and the third electronic device 300 are adjacent to one another, by receiving a response including information about adjacent electronic devices.

According to another embodiment, the server 400 (e.g., the confidence level comparing module 410) may transmit the result of comparing the received confidence levels, to electronic devices. For example, the server 400 may transmit the result of comparing the first confidence level, the second confidence level, and the third confidence level to the first electronic device 100, the second electronic device 200, and the third electronic device 300. According to an embodiment, the first electronic device 100, the second electronic device 200, and the third electronic device 300 may receive the result and may change the activation state based on the received result. For example, when the transmitted confidence level is higher than the confidence level transmitted by another electronic device, the first electronic device 100, the second electronic device 200, and the third electronic device 300 may change from the standby state of the electronic device to an activation state.

According to various embodiments of the disclosure described with reference to FIGS. 1 to 4, when the plurality of electronic devices 100, 200, and 300, in each of which the speech recognition function is activated by the same voice input, are positioned in a space capable of receiving utterance by the same user, the plurality of electronic devices 100, 200, and 300 may determine the electronic device, of which the speech recognition function is to be activated by the user, by analyzing the received voice input. Accordingly, it is possible to prevent another electronic device, which the user does not want, to be activated.

Furthermore, the plurality of electronic devices 100, 200, and 300 determined as receiving the same voice input may output a specified signal and may determine whether the plurality of electronic devices 100, 200, and 300 are adjacent to one another by receiving signals output from other electronic devices, thereby preventing an electronic device capable of activating the speech recognition function from being determined among the plurality of electronic devices 100, 200, and 300 positioned in different spaces. Accordingly, the speech recognition function of the electronic device desired by the user may be activated.

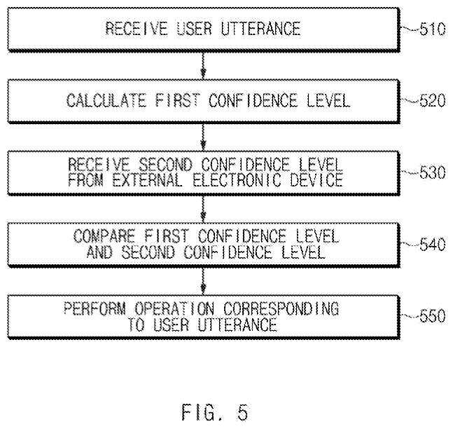

FIG. 5 is a flowchart illustrating a method of processing a voice input in an electronic device, according to an embodiment of the disclosure.

The flowchart illustrated in FIG. 5 may include operations that the first electronic device 100 and the second electronic device 200 described above process. Accordingly, even though omitted below, a description of the first electronic device 100 and the second electronic device 200 given with reference to FIGS. 1 to 4 may be applied to the flowchart illustrated in FIG. 5.

According to an embodiment, in operation 510, the first electronic device 100 may receive a voice input including a specified word. The specified word may be a trigger word for changing the state of the first electronic device 100.

According to an embodiment, in operation 520, the first electronic device 100 may calculate a first confidence level of the received voice input. The first confidence level may be calculated based on the sound pressure and the similarity between the received voice input and the voice signal stored in the memory.

According to an embodiment, in operation 530, the first electronic device 100 may receive a second confidence level of the voice input calculated by the second electronic device 200. For example, the second electronic device 200 may receive the same voice input as the voice input received from the first electronic device 100.

According to an embodiment, in operation 540, the first electronic device 100 may compare the first confidence level and the second confidence level.

According to an embodiment, in operation 550, the first electronic device 100 may perform an operation corresponding to the voice input when the first confidence level is higher than the second confidence level. For example, in the operation corresponding to the voice input, the standby state for recognizing only the voice input including a specified word may be changed to an activation state for recognizing the voice input for performing the overall operation of the first electronic device 100.

According to various embodiments, at least a part of an apparatus (e.g., modules or functions thereof) or a method (e.g., operations) may be, for example, implemented by instructions stored in a computer-readable storage media in the form of a program module. The instruction, when executed by a processor, may cause the processor to perform a function corresponding to the instruction. The computer-readable recording medium may include a hard disk, a floppy disk, a magnetic media (e.g., a magnetic tape), an optical medium (e.g., a compact disc read only memory (CD-ROM) and a digital versatile disc (DVD), a magneto-optical media (e.g., a floptical disk)), an embedded memory, or the like. The one or more instructions may contain a code made by a compiler or a code executable by an interpreter.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device comprising:
a communication circuit;
a memory;
a microphone; and
a processor electrically connected to the communication circuit, the microphone, and the memory,
wherein the processor is configured to:
receive a user utterance including a specified word through the microphone;
calculate a first confidence level of the received user utterance;
receive a second confidence level of the user utterance calculated by an external electronic device, from the external electronic device through the communication circuit;
compare the first confidence level and the second confidence level; and
when the first confidence level is higher than the second confidence level, perform an operation corresponding to the user utterance.

2. The electronic device of claim 1, wherein the first confidence level is calculated based on at least one of a similarity between the user utterance and a voice signal stored in the memory and a magnitude of sound pressure of the user utterance, and
wherein the second confidence level is calculated based on at least one of a similarity between the user utterance received by the external electronic device and a voice signal stored in the external electronic device and a magnitude of sound pressure of the user utterance received by the external electronic device.

3. The electronic device of claim 2, wherein the voice signal stored in the memory and the voice signal stored in the external electronic device are identical.

4. The electronic device of claim 1, wherein the processor compares the first confidence level and the second confidence level when the second confidence level is received within a specified time from a point in time when the user utterance is received.

5. The electronic device of claim 1, wherein the processor compares the first confidence level and the second confidence level when the electronic device and the external electronic device are connected to the same local network.

6. The electronic device of claim 1, wherein the processor compares the first confidence level and the second confidence level when a specified signal is received from the external electronic device through the microphone and a magnitude of the received signal is not less than a specified value.

7. The electronic device of claim 6, further comprising:
a speaker,
wherein the processor outputs the specified signal through the speaker.

8. The electronic device of claim 7, wherein the specified signal output through the speaker is an inaudible signal.

9. The electronic device of claim 1, wherein the operation corresponding to the user utterance is an operation of changing from a standby state for recognizing only the user utterance including the specified word to an activation state for recognizing a user utterance for performing an overall operation of the electronic device.

10. An electronic device comprising:
a communication circuit;
a memory;
a microphone; and
a processor electrically connected to the communication circuit, the microphone, and the memory,
wherein the processor is configured to:
receive a user utterance including a specified word through the microphone;
calculate a first confidence level of the received user utterance;
transmit the first confidence level to an external server through the communication circuit; and
when the first confidence level is higher than the second confidence level by comparing the first confidence level with a second confidence level of the user utterance calculated by an external electronic device through the external server, perform an operation corresponding to the user utterance.

11. The electronic device of claim 10, wherein the processor is configured to:
when the first confidence level is higher than the second confidence level, receive a request for performing the operation corresponding to the user utterance from the external server through the communication circuit; and
perform the operation corresponding to the user utterance depending on the received request.

12. The electronic device of claim 10, wherein the operation corresponding to the user utterance is an operation of changing from a standby state for recognizing only the user utterance including the specified word to an activation state for recognizing a user utterance for performing an overall operation of the electronic device.

13. A method for controlling an electronic device, the method comprising:
receiving a user utterance including a specified word;
calculating a first confidence level of the received user utterance;
receiving a second confidence level of the user utterance calculated by an external electronic device, from the external electronic device;
comparing the first confidence level and the second confidence level; and
when the first confidence level is higher than the second confidence level, performing an operation corresponding to the user utterance.

14. The method of claim 13, wherein the first confidence level is calculated based on at least one of a similarity between the user utterance and a voice signal stored in a memory and a magnitude of sound pressure of the user utterance, and
wherein the second confidence level is calculated based on at least one of a similarity between the user utterance received by the external electronic device and a voice signal stored in the external electronic device and a magnitude of sound pressure of the user utterance received by the external electronic device.

15. The method of claim 14, wherein the voice signal stored in the memory and the voice signal stored in the external electronic device are identical.
